(19) United States
(12) Patent Application Publication
(10) Pub. No.: US 2023/0041979 A1
(43) Pub. Date: Feb. 9, 2023

(54) CONTAINER WITH COVER HAVING A STOP BLOCK

(71) Applicant: STANLEY BLACK & DECKER MEA FZE, Jebel Ali (AE)

(72) Inventors: Shun-Chi YANG, Taichung City (TW); Hui-Ling TENG, Taichung City (TW); Ching-Yi TU, Taichung City (TW); ChihChiang LEE, Taichung (TW); Bennett G. RECORDS, East Haven, CT (US); Wan-Chiang WANG, Taichung City (TW)

(21) Appl. No.: 17/879,951

(22) Filed: Aug. 3, 2022

(30) Foreign Application Priority Data
Aug. 5, 2021 (EP) 21189875.4

(51) Int. Cl. B65D 43/16; B65D 43/22

(52) U.S. Cl. CPC B65D 43/164; B65D 43/22; B65D 2251/04

(57) ABSTRACT

The present invention relates to a container. More specifically, it relates to a container having a lower portion with a bottom and a plurality of walls defining an interior space. The container also includes a cover attached to one of the walls via a hinge and configured to move between a closed position and a fully open position, wherein in said closed position, access to the interior space is prohibited, and in said fully open position, access to the interior space is permitted and the cover is at an angle (α) of greater than or equal to 90 degrees with respect to the lower portion.

### CROSS-REFERENCE TO RELATED APPLICATION

This application claims priority from European Community Design Application No. 008696785-0001, filed Sep. 20, 2021, the disclosure of which is incorporated herein by reference.

### FIELD OF INVENTION

The present invention relates to a container. More specifically, the invention relates to a container with a cover having a stop block.

### BACKGROUND OF THE INVENTION

The general concept of a container having a cover is well known. Such containers can be used in a variety of settings for organizing and transporting goods. In the construction setting, such containers may be used to organize and transport tools or accessories, such as fasteners or drill bits. In such a setting, it is not uncommon for a carpenter to require ongoing access to the interior of the container. Thus, a container having a cover that can remain open without additional intervention from the operator is needed. In the past, this problem has been overcome by containers utilizing a kick stand or leg that can support the cover in an open position. However, such kick stands are expensive to manufacture. The present invention overcomes one or more of these drawbacks.

### SUMMARY OF THE INVENTION

An aim of the present disclosure is to provide a cost-efficient container having a cover that is movable between a fully closed position and a fully open position, and wherein the cover can also remain open in an intermediate open position without additional intervention from an operator.

To this end, it is proposed a container according to claim 1. Specifically, a container including a lower portion having a bottom and a plurality of walls, all of which define an interior space. The container further includes a cover that is attached to one of the walls via a hinge. The cover is configured to move between a closed position and a fully open position, wherein in said closed position, access to the interior space is prohibited. In the fully open position, access to the interior space is permitted and the cover is at an angle (α) of greater than or equal to 90 degrees with respect to the lower portion. The container is characterized in that the cover includes at least one stop block adjacent the hinge and configured to engage a lip of the wall to which the cover is hinged and hold the cover at an intermediate open position. In the intermediate open position, access to the interior space is permitted and the cover is at an angle (β) of less than 90 degrees with respect to the lower portion.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of "a", "an", and "the" include plural referents unless the context clearly dictates otherwise.

### BRIEF DESCRIPTION OF THE DRAWINGS

Features of the tool in accordance with one or more embodiments are shown in the drawings, in which like reference numerals designate like elements. The drawings form part of this original disclosure in which:

FIG. 1 illustrates a perspective view of a container according the present disclosure;

FIG. 2 illustrates an exploded view of the container;

FIG. 3 illustrates a detailed view of a hinge of the container;

FIG. 4 illustrates a detailed view of a rotative portion of the hinge of the container;

FIG. 5 illustrates a detailed view of a hook portion of the hinge of the container;

FIG. 6 illustrates a first perspective cutaway view of the hinge of the container in its closed position;

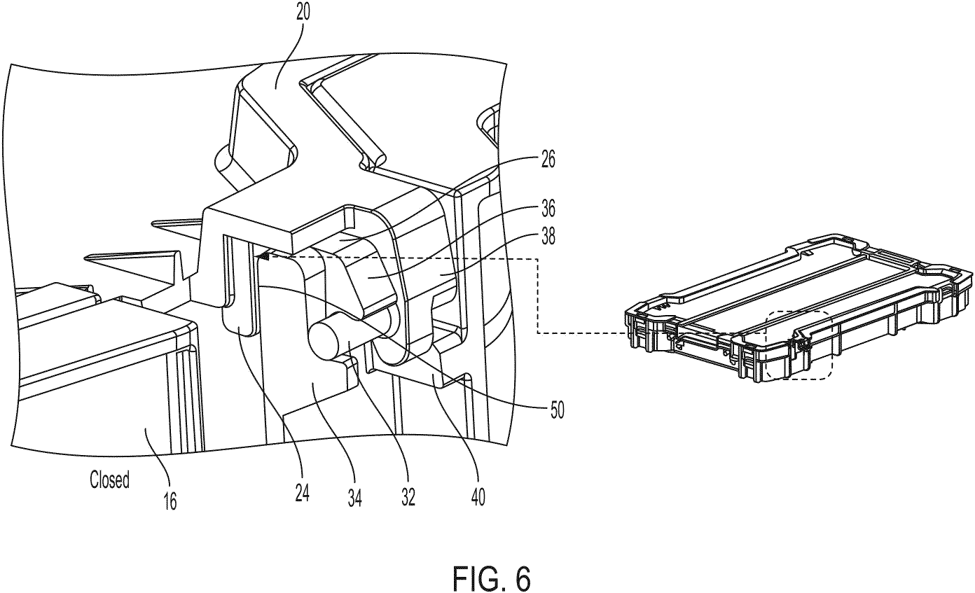

FIG. 7 illustrates a second perspective cutaway view of the hinge of the container in its closed position;

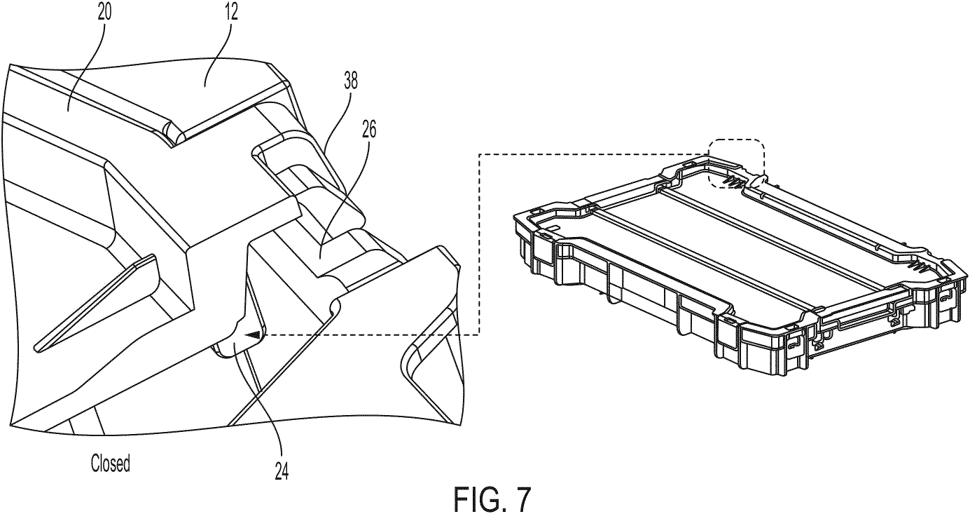

FIG. 8 illustrates a first perspective cutaway view of the hinge of the container in its intermediate open position;

FIG. 9 illustrates a second perspective cutaway view of the hinge of the container in its intermediate open position;

FIG. 10 a first perspective cutaway view of the hinge of the container in its fully open position;

FIG. 11 illustrates a second perspective cutaway view of the hinge of the container in its fully open position; and

FIG. 12 illustrates a side-by-side comparison of a stress simulation showing the improved strength of the cover of present disclosure.

### DETAILED DESCRIPTION OF THE ILLUSTRATED EMBODIMENT(S

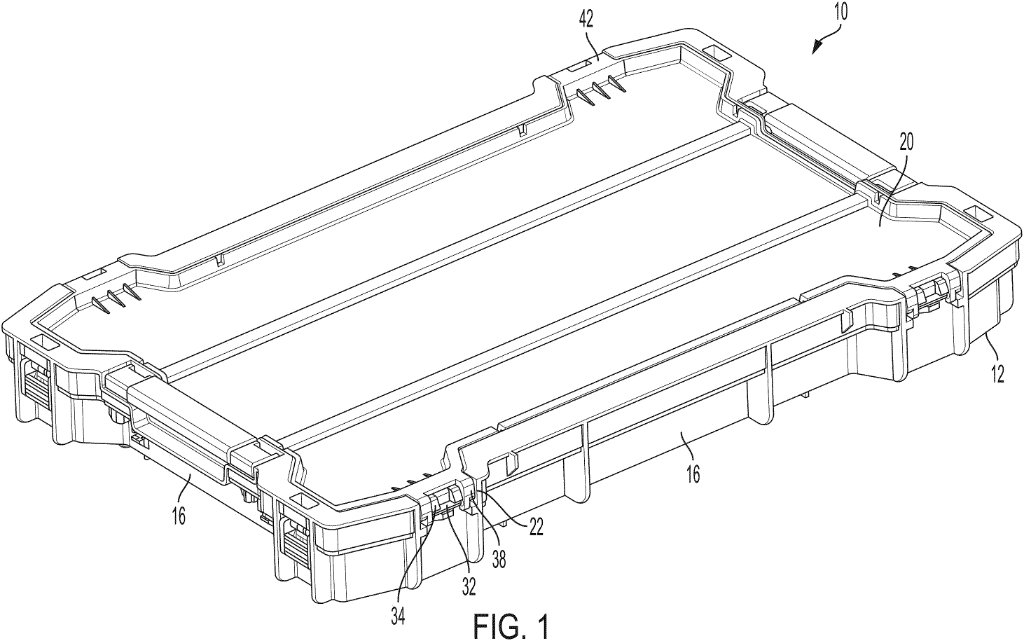

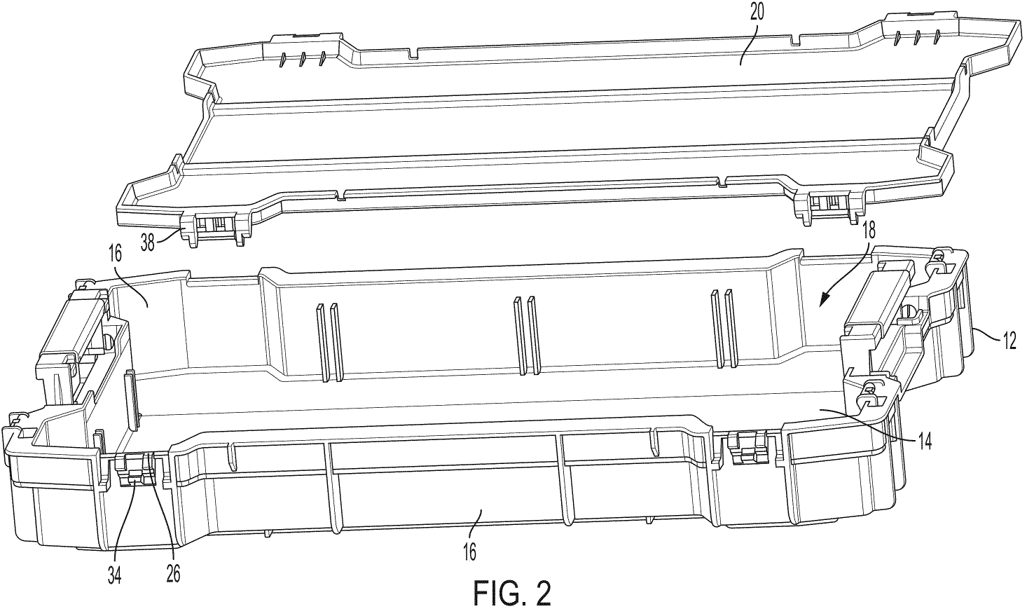

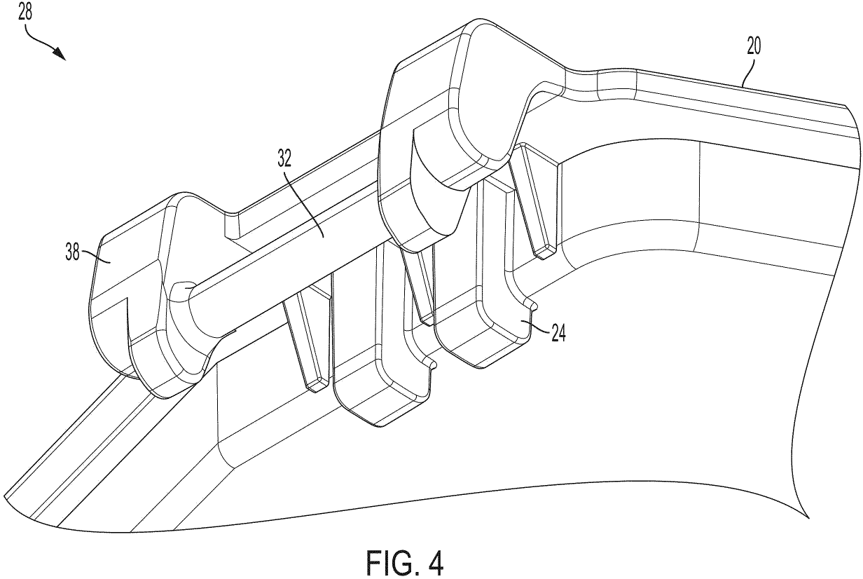

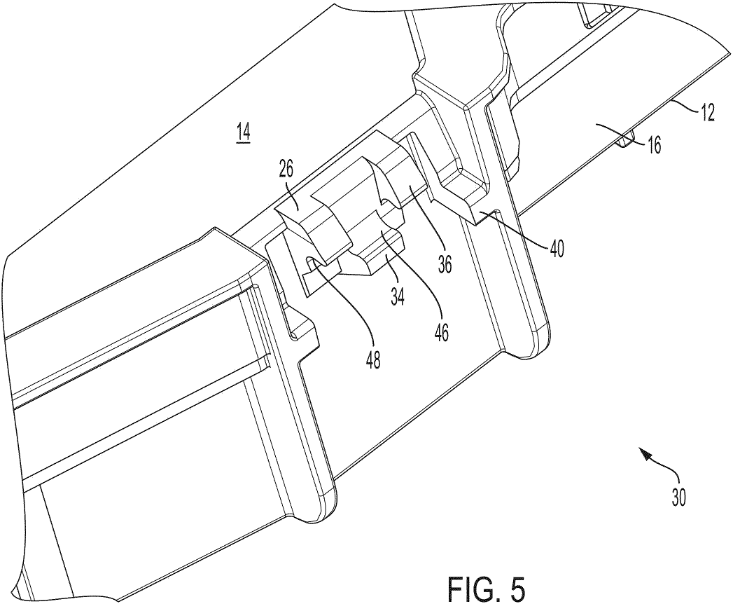

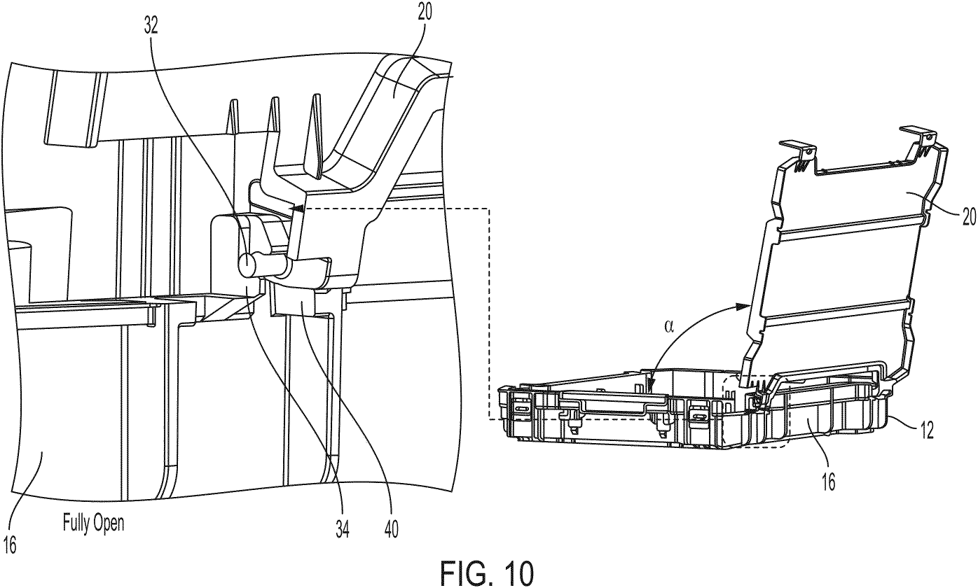

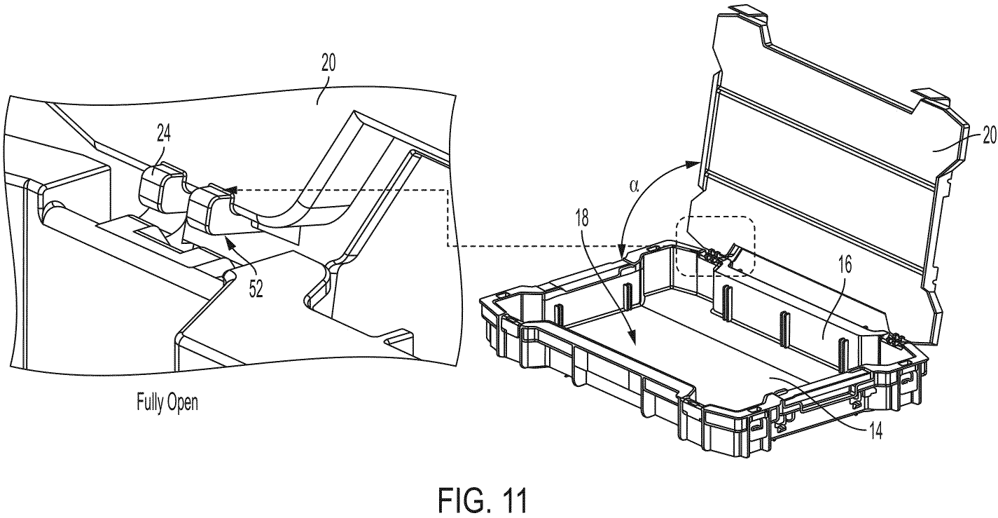

FIGS. 1 and 2 illustrates a container 10 of the present invention. The container 10 includes a lower portion 12 having a bottom 14, and a plurality of walls 16 defining an interior space 18. The container also includes a cover 20 attached to one the walls 16 by one or more hinges 22. The cover 20 is configured to move between a closed position and a fully open position (see FIGS. 10-11). In the closed position, the cover 20 prohibits access to the interior space 18. In the fully open position, access to the interior space 18 is permitted. Additionally, in the fully open position, the cover is at an angle (α) of greater than or equal to 90 degrees with respect to the lower portion 12. The cover 20 includes at least one primary stop block 24 that is adjacent to the hinge 22 and configured to engage a lip 26 of the wall 16 that the cover 20 is hinged to. The stop block 24 is further configured to hold the cover 20 at an intermediate open position (best shown in FIGS. 4-5), wherein access to the interior space 18 is permitted and the cover 20 is at angle (β) of less than 90 degrees with respect to the lower portion 12.

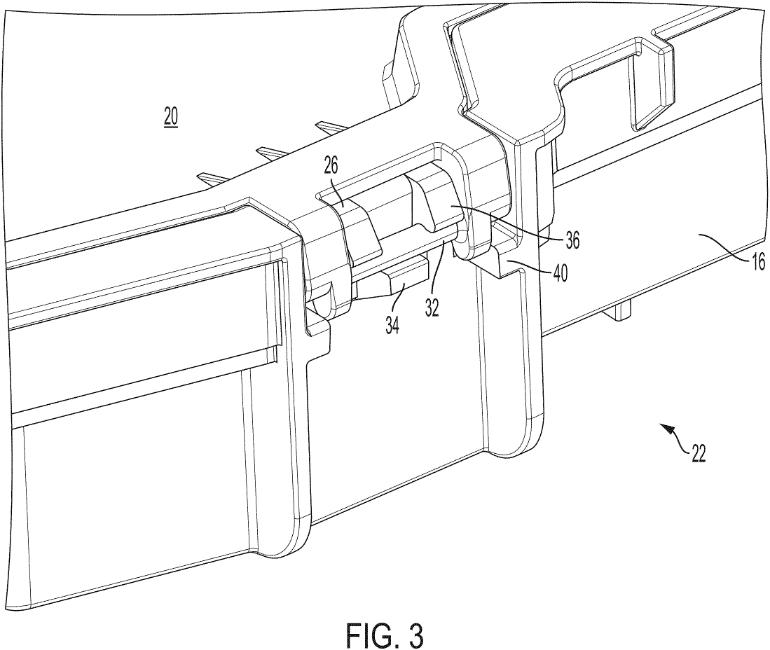

As best seen in FIGS. 3-5, the hinge 22 of the container 10 includes a rotative portion 28 and a hook portion 30. The hook portion 30 is configured to engage the rotative portion 28 and facilitate its rotation. In a preferred embodiment, the rotative portion 28 is integrated into the cover 20 and the hook portion 30 is integrated into the lower portion 12. Preferably, the rotative portion 28 includes a horizontal bar 32 that is substantially cylindrical. The hook portion 30 preferably includes both a lower engagement portion 34 and an upper engagement portion 36. When constructed, the horizontal bar 32 is positioned between the lower engagement portion 34 and the upper engagement portion 36. Preferably, the respective interior surfaces 46, 48 of the lower engagement portion 34 and upper engagement portion 36 are arcuate. The arcuate interior surfaces 46, 48 engage and facilitate the rotation of the substantially cylindrical horizonal bar 32.

In a preferred embodiment, the cover 20 further included a secondary stop surface 38 that is adjacent the hinge 22. The secondary stop surface 38 is preferably integrated into the rotative portion 28 of the hinge 22. The secondary stop surface 38 is configured to engage a holding block 40 on the lower portion 12. When the secondary stop surface 38 engages the holding block 40, it both holds the cover 20 in a fully open position and prevents the cover from falling to a fully open position, wherein the angle (α) is greater than 180 degrees.

Those skilled in the art will recognize that the container 10 can further include a myriad of features in common with other containers such as closing means 42. The closing means 42 is configured to secure the cover 20 of the container 10 in its closed position. The closing means 42 may be a latch 44 or other standard closing means.

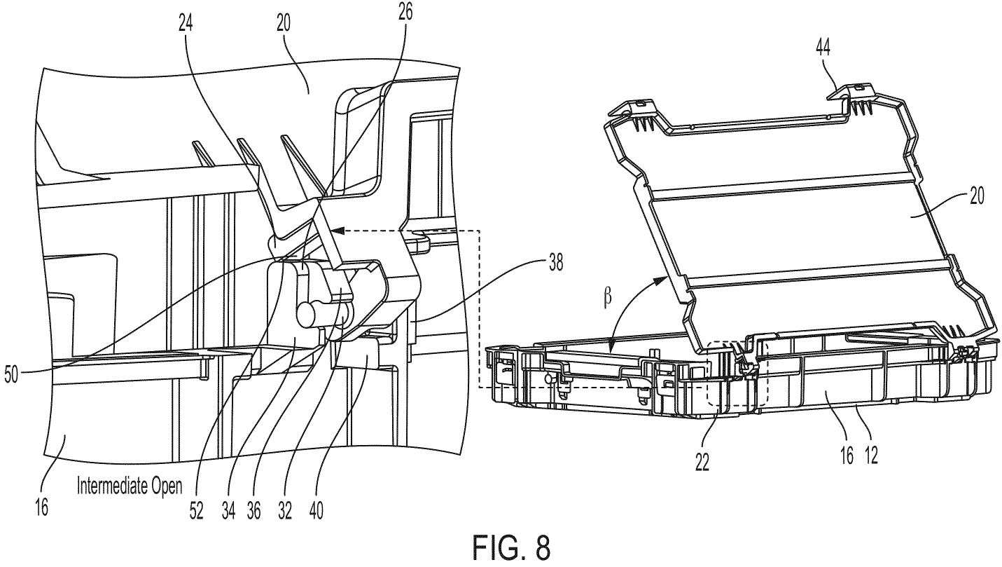

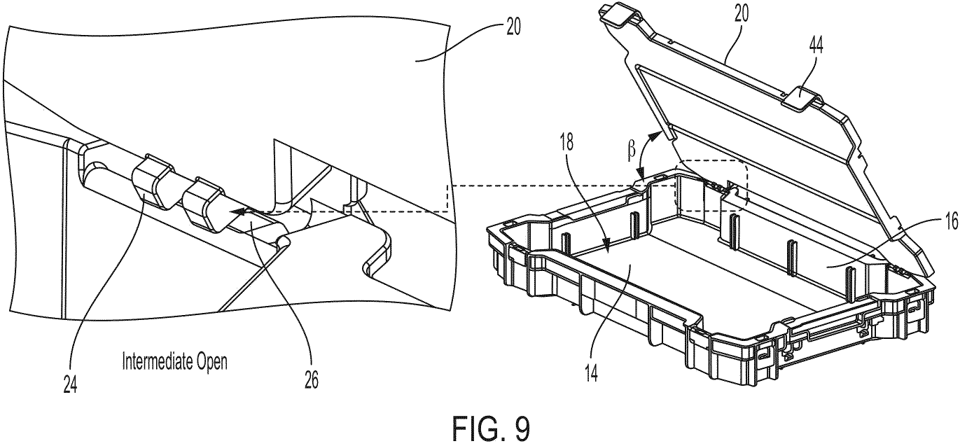

In operation, the cover 20 of the container 10 of the present disclosure selectively moves back and forth between a closed position and a fully open position. That movement will now be described. Starting from a closed position as shown in FIG. 1, an operator desiring to gain access to to the interior space 18 will disengage the closing means 42 and raise the cover 20 away from lower portion 12. Eventually, the cover 20 will reach a position just shy of the intermediate open position. As best seen in FIGS. 8 and 9, when the cover reaches a position just shy of the intermediate open position, the at least one stop block 24 comes into first contact with lip 26 of the wall to which the cover 20 is hinged. More specifically, the back surface 50 of the stop block 24 comes into contact with the lip 26. Should the operator desire quick access to the interior space 18, she can easily access the same at this point. However, due to the weight of the cantilevered cover 20, should she release the cover 20 at this point, it will fall back to its closed position under the influence of gravity.

However, should she desire for the cover to remain open at the intermediate open position, she will simply apply pressure to the cover so that it moves from a position just shy of the intermediate open position to a position just beyond the intermediate open position. When this occurs, the stop block 24 will rotate from a position wherein its back surface 50 engages the of the lip 26 to a position, wherein the stop block 24 clears the lip 26 entirely. When the cover 20 reaches this position, the operator can release the cover 20 and as it falls back towards its closed position under the influence of gravity, a bottom surface 52 of the stop block 24 comes into contact with the lip 26. The at least one stop block 24 is sized such that it when the bottom surface 52 thereof engages lip 26, it can support the weight of the cover 20 such that the cover 20 will remain in the intermediate open position and not fall to the closed position. See FIGS. 8-9. Those skilled in the art will recognize that multiple stop blocks 24 may be used to help support the weight of the cover.

Turning now to FIGS. 9-10, when the operator desires to move the cover 20 to its fully open position, she rotates the cover 20 away from the intermediate open position toward its fully open position. When the cover reaches its fully open position, the secondary stop surface 38 engages the holding block 40. In this position, the operator may release the cover. However, due to the obtuse angle of the cover 20 with respect to the lower portion 12; instead of falling under the influence of gravity toward the closed position, the cover will fall toward a fully open position wherein it would form an angle of 180 degrees or greater. However, due to the position of the of the holding block 40, the cover 20 is prevented from falling to a position wherein it forms an angle of 180 or greater. Similar to the stop block 24, the portion of the cover 20 including the secondary stop surface is sized such that it can support the weight of the cover. Those skilled in the art will recognize that one or more secondary stop surfaces 38 may be employed to help support the weight of the cover in its fully open position.

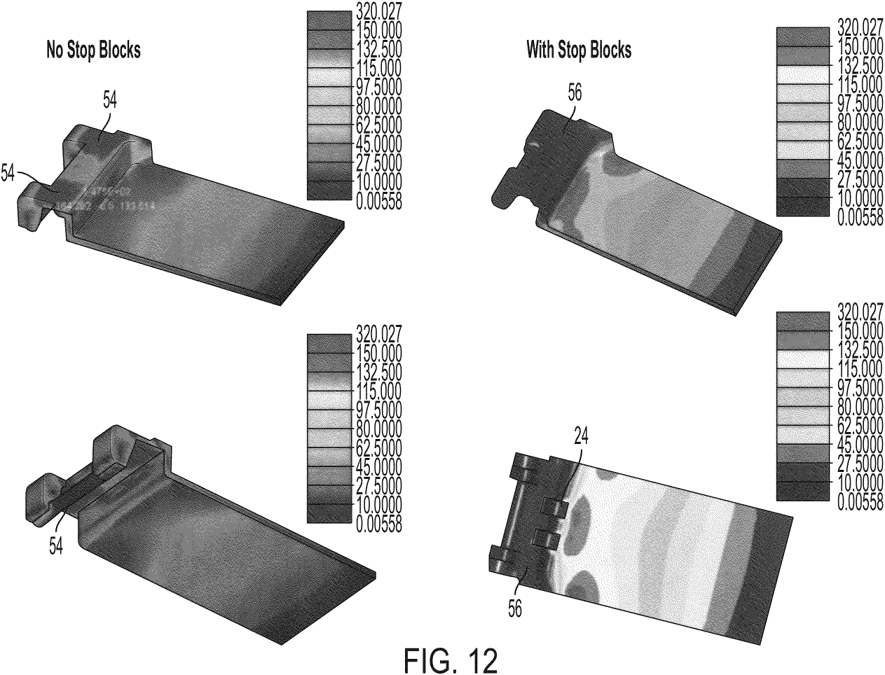

Finally, as shown in FIG. 12, the position of the at least one stop block 24 on the cover 20 and adjacent the hinge 22 provides an unexpected benefit of added strength to the cover 20. Computer simulations show that the cover 20 may have one or more weak points 54 wherein it can be broken. The inclusion of the one or more stop blocks 24 adjacent these weak points provide additional structural support to the cover 20. Computer simulations show that stop blocks 24 add strength to the weak points and make them points of added strength 56.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims.

What is claimed:

1. A container comprising:
a lower portion having a bottom and plurality of walls defining an interior space;
a cover attached to one of said walls via a hinge and configured to move between a closed position and a fully open position, wherein in said closed position, access to the interior space is prohibited, and in said fully open position, access to the interior space is permitted and the cover is at an angle of greater than or equal to 90 degrees with respect to the lower portion; and
characterized in that the cover includes at least one stop block adjacent the hinge and configured to engage a lip of the wall to which the cover is hinged and hold the cover at an intermediate open position, wherein access to the interior space is permitted and the cover is at an angle of less than 90 degrees with respect to the lower portion.

2. The container of claim 1, wherein the hinge includes a rotative portion and a hook portion configured to engage the rotative portion and permit its rotation.

3. The container of claim 2, wherein the rotative portion is integrated into the cover and the hook portion is integrated into the lower portion.

4. The container of claim 3, wherein the rotative portion includes a horizontal bar that is substantially cylindrical; and the hook portion includes both a lower engagement portion and an upper engagement portion.

5. The container of claim 2, wherein the cover further includes a secondary stop surface adjacent the hinge and configured to engage a holding block on the lower portion and both hold the cover in a fully open position and prevent the cover from falling to a fully open position of greater than 180 degrees.

6. The container of claim 3, wherein the cover further includes a secondary stop surface adjacent the hinge and configured to engage a holding block on the lower portion and both hold the cover in a fully open position and prevent the cover from falling to a fully open position of greater than 180 degrees.

7. The container of claim 4, wherein the cover further includes a secondary stop surface adjacent the hinge and configured to engage a holding block on the lower portion and both hold the cover in a fully open position and prevent the cover from falling to a fully open position of greater than 180 degrees.

8. The container of claim 1, further including closing means configured to secure the cover in the closed position.

9. The container of claim 2, further including closing means configured to secure the cover in the closed position.

10. The container of claim 3, further including closing means configured to secure the cover in the closed position.

11. The container of claim 8, wherein the closing means includes a latch.

12. The container of claim 1, wherein the stop block is positioned on the cover such that it provides additional structural support to the cover.

13. The container of claim 2, wherein the stop block is positioned on the cover such that it provides additional structural support to the cover.

14. The container of claim 3, wherein the stop block is positioned on the cover such that it provides additional structural support to the cover.

15. The container of claim 4, wherein the stop block is positioned on the cover such that it provides additional structural support to the cover.

16. The container of claim 8, wherein the stop block is positioned on the cover such that it provides additional structural support to the cover.

17. The container of claim 11, wherein the stop block is positioned on the cover such that it provides additional structural support to the cover.

18. The container of claim 12, wherein the stop block is positioned on the cover such that it provides additional structural support to the cover.
